(19) United States
(12) Patent Application Publication
(10) Pub. No.: US 2026/0243598 A1
(43) Pub. Date: Aug. 20, 2026

(54) STRAY LIGHT REMOVAL SYSTEM AND METHOD FOR ITS REMOVAL

(71) Applicant: AGENCY FOR DEFENSE DEVELOPMENT, Daejeon (KR)

(72) Inventors: Ji Hun BAE, Daejeon (KR); Kwang Woo PARK, Daejeon (KR)

(21) Appl. No.: 19/327,428

(22) Filed: Sep. 12, 2025

(30) Foreign Application Priority Data
Feb. 20, 2025 (KR) 10-2025-0021982

(51) Int. Cl. G01J 1/04

(52) U.S. Cl. CPC G01J 1/0403

(57) ABSTRACT

The purpose of the present disclosure is to provide a stray light removal system and a method for removing stray light, which can simultaneously improve optical performance, energy efficiency, and mechanical performance of a EO/IR system and a flight vehicle through weight reduction, energy self-generation, and selective activation technology utilizing an electroactive polymer or a photoactive polymer. An aspect of the present disclosure provides a stray light removal system, comprising: a sensing unit configured to detect stray light or external stimuli and generate an electric signal; an electrode unit configured to control and transmit the generated electric signal; a control unit configured to analyze stray light intensity based on the transmitted electric signal; a driving unit configured to operate under control of the control unit; and a baffle, wherein a length or an angle of the baffle is adjusted by operation of the driving unit to remove the stray light.

### CROSS-REFERENCE TO RELATED APPLICATION

This application claims priority to Korean Patent Application No. 10-2025-0021982 filed on Feb. 20, 2025, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a stray light removal system and a method for removing stray light. In particular, the present disclosure relates to a system and method to which an electroactive material or a photoactive material is applied for removing stray light.

### Description of the Related Art

The Electro-Optical/Infra-Red system (hereinafter referred to as “the EO/IR system”) of a flight vehicle has the function of detecting or tracking a target.

The EO/IR system is mounted on the flight vehicle to perform infrared image detection and tracking.

The EO/IR system detects the infrared signals of the target to track and guide the flight vehicle toward the target.

FIG. 1 is a diagram illustrating an example of the EO/IR system's optical system.

Referring to FIG. 1, the basic components of the EO/IR system include an optical system and an infrared detector. The optical system comprises elements such as mirrors 20a and 20b, a sunshade 10, and a baffle.

These components are essential for minimizing the effect of solar stray light and acquiring high-quality infrared images of the target.

However, in order for the EO/IR system to obtain high-quality infrared images of the target during flight, it is essential to remove stray light caused by direct sunlight, the ground surface, clouds, and other sources.

That is, the optical system of the EO/IR system may be affected by stray light resulting from direct sunlight or light reflected from the ground or clouds.

Such stray light causes the following problems:

Degradation of infrared image quality: Optical distortions such as vignetting may occur due to stray light, which results in blurry infrared images of the target or increases the possibility of false detection.

False detection: Stray light may appear as bright spots in the infrared image, which could be misidentified as a target, potentially leading to mission failure.

Increase in system weight: Metal sunshades and baffles are typically used to eliminate stray light, but these components increase the overall system weight, thereby degrading the flight vehicle's performance.

To address this, sunshades, baffles, and similar components are generally installed to block or minimize stray light.

However, these methods may block part (or a significant portion) of the infrared energy required to achieve the desired optical performance, or lead to increased weight of the optical system.

Moreover, optical distortions such as vignetting caused by stray light degrade the optical performance of the EO/IR system, particularly the quality of the infrared image of the target.

In some cases, bright spots with intensity beyond a certain level caused by stray light may appear in the infrared image, resulting in false recognition as a target and ultimately mission failure.

Additionally, the increased weight of the optical system negatively affects the optimization of the flight vehicle's mechanical performance.

Therefore, there is a significant challenge in simultaneously maximizing the optical performance and reducing the weight of the EO/IR system, while completely removing stray light.

### RELATED PATENT DOCUMENT

Korean Registered Patent Publication No. 10-2757162

### SUMMARY OF THE DISCLOSURE

The purpose of the present disclosure, which aims to solve the aforementioned conventional problems, is to provide a stray light removal system and a method for removing stray light, which can simultaneously improve optical performance, energy efficiency, and mechanical performance of a EO/IR system and a flight vehicle through weight reduction, energy self-generation, and selective activation technology utilizing an electroactive polymer or a photoactive polymer.

In addition, the purpose of the present disclosure is to provide a stray light removal system and a method for removing stray light, which can prevent the influence of direct sunlight, ground-reflected light, clouds, and the like, and secure high-quality infrared images of a target by completely removing or minimizing stray light generated when using a conventional metal baffle or sunshade, thereby improving the accuracy of target detection and tracking and preventing false detection.

In addition, the purpose of the present disclosure is to provide a stray light removal system and a method for removing stray light, which maximizes the mechanical performance (speed, flight distance, etc.) of a flight vehicle by designing a lightweight baffle using an Electro Active Polymer (EAP) and a photoactive material to reduce the overall weight of the flight vehicle, thereby solving the problem of increased weight of a conventional metal baffle.

In addition, the purpose of the present disclosure is to provide a stray light removal system and a method for removing stray light, which can harvest and store electric energy by self-generation using external stimuli (heat, vibration, shock, etc.) and recycle the stored energy for activation of the baffle, thereby eliminating the need for a separate power supply device.

In addition, the purpose of the present disclosure is to provide a stray light removal system and a method for removing stray light, in which the baffle is not permanently installed and can be selectively activated only at specific times and sections where stray light removal is required, thereby reducing unnecessary energy consumption and preventing deterioration of the optical performance of the EO/IR system.

In addition, the purpose of the present disclosure is to provide a stray light removal system and a method for removing stray light, which maximizes stability and reliability of the EO/IR system and minimizes errors that may occur during a mission by configuring a sensing unit and a driving unit of the EO/IR system to detect environmental changes in real time and immediately activate the baffle to remove stray light accordingly.

In addition, the purpose of the present disclosure is to provide s a stray light removal system and a method for removing stray light, which can maximize the performance of a flight vehicle by maintaining or improving infrared image detection performance while achieving weight reduction and efficient energy use along with stray light removal.

In order to achieve the purpose, an aspect of the present disclosure provides a stray light removal system, comprising: a sensing unit configured to detect stray light or external stimuli and generate an electric signal; an electrode unit configured to control and transmit the generated electric signal; a control unit configured to analyze stray light intensity based on the transmitted electric signal; a driving unit configured to operate under control of the control unit; and a baffle, wherein a length or an angle of the baffle is adjusted by operation of the driving unit to remove the stray light.

In some exemplary embodiment, the control unit may be configured to supply electric energy to the driving unit, to derive baffle activation shape parameters, and to provide a baffle activation command.

In some exemplary embodiment, the baffle may include an electroactive polymer (EAP: Electro Active Polymer) material and a photoactive material.

In some exemplary embodiment, the electroactive polymer material may be one selected from the group consisting of a polymer material of a ferroelectric polymer series, a polymer material of a dielectric elastomer series, and a material in which the polymer material of a ferroelectric polymer series is mixed with the polymer material of a dielectric elastomer series.

In some exemplary embodiment, the photoactive material may be a material of an antimony chalcohalide series.

In some exemplary embodiment, the driving unit may include an electroactive polymer of a dielectric elastomer series.

In some exemplary embodiment, the sensing unit may include an electroactive polymer material of a ferroelectric polymer series and a photoactive material configured to generate the electric signal depending on an intensity of the stray light.

In some exemplary embodiment, the sensing unit may generate electric energy according to deformation of the electroactive polymer material upon a change in the external stimuli, and may collect and store the generated electric energy in real time through the electrode unit.

In some exemplary embodiment, the sensing unit may generate electric energy through the electrode unit according to a photoelectric reaction of the photoactive material upon a change in the stray light.

In addition, in order to achieve the purpose, another aspect of the present disclosure provides a method for removing stray light, comprising: a first step, by a sensing unit, of detecting stray light or external stimuli and generating an electric signal; a second step, by an electrode unit, of controlling and transmitting the generated electric signal; a third step, by a control unit, of analyzing stray light intensity based on the transmitted electric signal; a fourth step of operating a driving unit under control of the control unit; and a fifth step of removing the stray light by a baffle, wherein a length or an angle of the baffle is adjusted by operation of the driving unit.

In some exemplary embodiments, the control unit may be configured to supply electric energy to the driving unit, to derive baffle activation shape parameters, and to provide a baffle activation command.

In some exemplary embodiments, the baffle may include an electroactive polymer (EAP: Electro Active Polymer) material and a photoactive material.

In some exemplary embodiments, the electroactive polymer material may be one selected from the group consisting of a polymer material of a ferroelectric polymer series, a polymer material of a dielectric elastomer series, and a material in which the polymer material of a ferroelectric polymer series is mixed with the polymer material of a dielectric elastomer series.

In some exemplary embodiments, the photoactive material may be a material of an antimony chalcohalide series.

In some exemplary embodiments, the driving unit may include an electroactive polymer of a dielectric elastomer series.

In some exemplary embodiments, the sensing unit may include an electroactive polymer material of a ferroelectric polymer series and a photoactive material configured to generate the electric signal depending on an intensity of the stray light.

In some exemplary embodiments, the sensing unit may generate electric energy according to deformation of the electroactive polymer material upon a change in the external stimuli, and may collect and store the generated electric energy in real time through the electrode unit.

In some exemplary embodiments, the sensing unit may generate electric energy through the electrode unit according to a photoelectric reaction of the photoactive material upon a change in the stray light.

Meanwhile, in order to achieve the purpose, a stray light removal system is provided.

The stray light removal system may be operated by the aforementioned method for removing stray light.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, it is possible to effectively remove stray light generated by direct sunlight, clouds, ground-reflected light, and the like, thereby obtaining high-quality infrared images, improving detection and tracking performance of a EO/IR system by removing the stray light, and minimizing the possibility of false detection.

Furthermore, according to the present disclosure, it is possible to solve the problem in which a conventional metal baffle partially blocks infrared energy and deteriorates optical performance, to maintain or improve the quality of an infrared signal while removing stray light, and to provide stable and clear infrared images by eliminating vignetting phenomena and distortions caused by bright spots.

Furthermore, according to the present disclosure, by using an Electroactive Polymer (EAP) and a photoactive material instead of a conventional metal baffle, it is possible to significantly reduce the weight of the baffle, improve mechanical performance, flight speed, and flight range of a flight vehicle, and maximize flight vehicle performance through system weight reduction.

Furthermore, according to the present disclosure, by harvesting electric energy through self-generation using external stimuli (vibration, heat, shock, etc.), storing the electric energy, and using it for baffle activation, it is possible to achieve efficient energy use without a separate power supply device and to solve energy supply problems.

Furthermore, according to the present disclosure, a system composed of a sensing unit and a driving unit detects changes in an external environment in real time, activates the baffle only when necessary, and locally operates the baffle, thereby reducing unnecessary energy consumption and preventing deterioration of optical performance.

Furthermore, according to the present disclosure, since the system can actively respond to various external stimuli such as vibration, heat, and shock generated during flight, and can perform self-generation and baffle activation, stable operation is possible under various environmental conditions.

Furthermore, according to the present disclosure, bright spots in infrared images caused by stray light can be effectively removed, enabling accurate detection and tracking of a target, minimizing detection errors, reducing the possibility of mission failure, and improving system reliability.

Furthermore, according to the present disclosure, the shape and activation area of the baffle can be flexibly designed to match the posture and angle conditions of a specific flight vehicle, and various types of photoactive materials or hybrid structures of metal and electroactive polymers can be applied as needed, thereby providing high versatility.

### BRIEF DESCRIPTION OF THE DRAWINGS

FIG. 1 is a diagram illustrating an example of an optical system of a EO/IR system.

FIG. 2 is a diagram illustrating an optical system to which an electroactive or photoactive baffle according to the present disclosure is applied.

FIG. 3 is a diagram illustrating before and after activation of an electroactive or photoactive baffle according to the present disclosure.

FIG. 4 is a graph illustrating a change in solar stray light depending on an incident angle.

FIG. 5 is a block diagram illustrating a configuration of a stray light removal system according to an embodiment of the present disclosure.

FIG. 6 is a diagram illustrating a flow in which a EO/IR system detects or tracks a target and makes a direct hit.

FIG. 7 is a flowchart illustrating an overall flow of a stray light removal method according to another embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

Hereinafter, exemplary embodiments of the present disclosure will be described in detail with reference to related drawings.

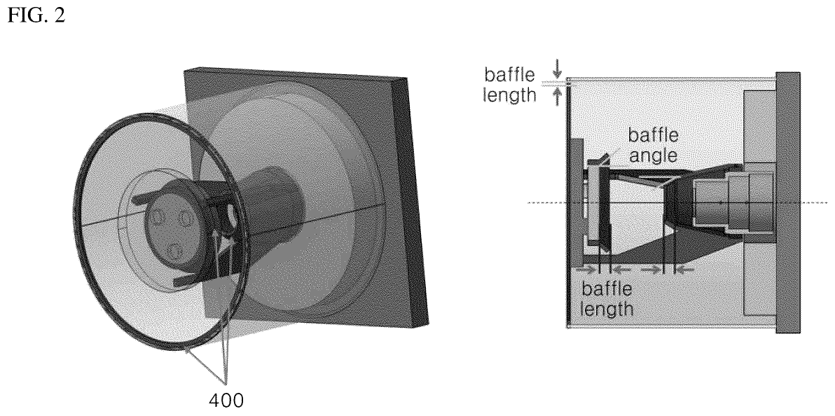

FIG. 2 is a diagram illustrating an optical system to which an electroactive or photoactive baffle according to the present disclosure is applied.

Referring to FIG. 2, an infrared imaging EO/IR system of a flight vehicle has a function of detecting and tracking a target.

Such an infrared imaging EO/IR system includes an optical system, an infrared detector, and the like.

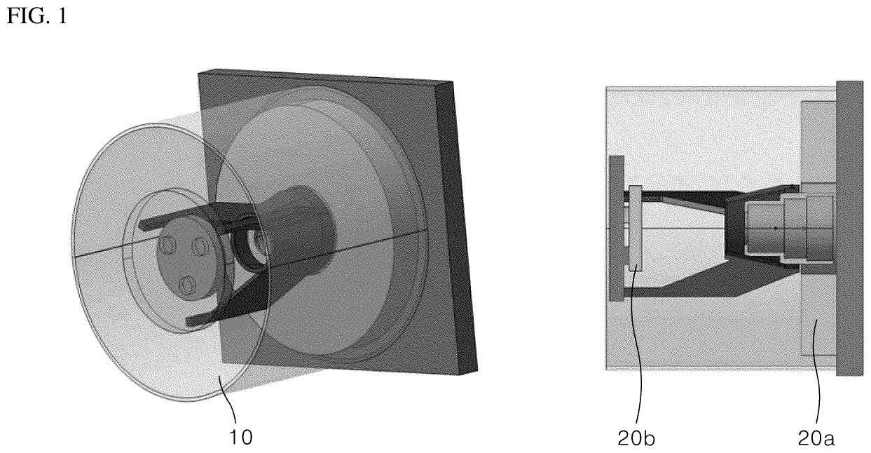

In addition, as described in FIG. 1, the optical system includes reflectors 20a, 20b, a sunshade 10, a baffle 400, and the like.

In order to obtain a high-quality infrared image of a target, it is essential to remove stray light caused by direct sunlight and by the ground, clouds, and the like, which may occur during flight.

Therefore, generally, the sunshade 10, the baffle 400, and the like are installed to remove or minimize stray light.

In this exemplary embodiment, since the baffle 400 is made of a polymer, it can be designed to be lighter than a conventional baffle made of a typical metal material, and it can be selectively applied only at specific times when removal or minimization of stray light is required, rather than being permanently installed, thereby avoiding the problem of deterioration in the optical performance of the EO/IR system in which a baffle made of a conventional rigid material such as metal is applied.

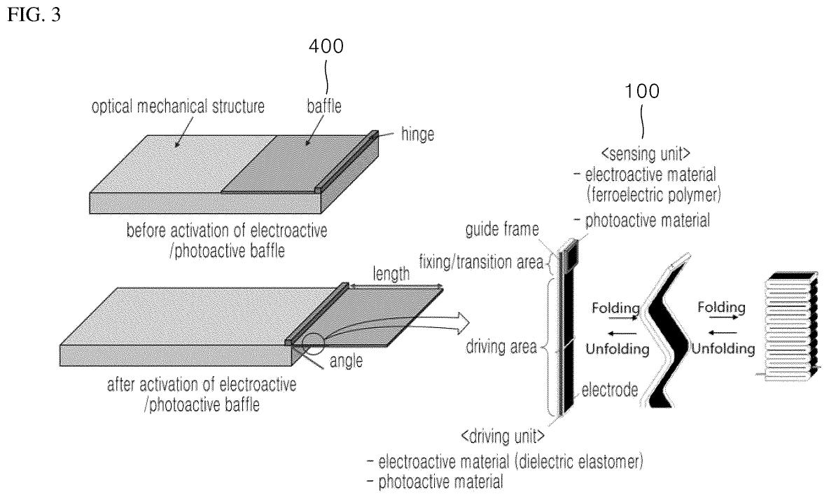

FIG. 3 is a diagram illustrating before and after activation of an electroactive or photoactive baffle according to the present disclosure.

Referring to FIG. 3, the structure and operating principle of an electroactive or photoactive baffle 400 for removing stray light are illustrated.

In particular, the baffle 400 includes a sensing unit 100 and a driving unit 300, and as the baffle 400 is activated, its length and angle can be adjusted.

In view of the base structure to which the baffle 400 is mounted, the baffle 400 has a variable structure that operates to remove stray light.

A hinge is a connecting part that allows the baffle 400 to move at a specific angle.

The sensing unit 100 is a detection system including an electroactive material such as a ferroelectric polymer or a photoactive material.

The driving unit 300 is a driving device of the baffle 400 made of a dielectric elastomer.

When the stray light exceeds a certain threshold, the baffle 400 is automatically activated to block the stray light.

In an initial state before activation, the baffle 400 is maintained in a flat form attached to the optical mechanical structure.

In this state, blocking of stray light is not necessary, and the sensing unit 100 continuously monitors the amount of light.

The sensing unit 100 may be composed of an electroactive material or a photoactive material.

The sensing unit 100 detects the intensity of the stray light, generates an electric signal in response to external stimuli such as heat, vibration, or shock, and transmits the generated electric signal through an electrode to activate the driving unit 300.

Since the sensing unit 100 has a self-powering function, it can operate without an external power supply.

That is, a photoactive material detects sunlight and generates electric energy.

The driving unit 300 may include an electroactive polymer based on a dielectric elastomer.

The driving unit 300 deforms the baffle based on the electric signal transmitted from the sensing unit 100.

The baffle 400 moves to a specific angle to block the stray light and can return to its original flat form when no longer needed.

At this time, the length and angle of the baffle 400 can be adjusted to perform optimal stray light removal.

In other words, the baffle 400 can operate flexibly through folding and unfolding operations.

In the figure, after the baffle 400 is fully activated, its length and angle are adjusted.

As the length of the baffle 400 extends (stretching), it can block stray light over a wider area.

This deformation utilizes the electromechanical properties of the electroactive polymer.

Furthermore, the baffle 400 can rotate at a specific angle around the hinge to effectively block stray light entering the optical system.

The angle adjustment can be precisely controlled according to the magnitude of the voltage supplied from the driving unit 300.

By this deformation method of the baffle 400, stray light can be removed without unnecessary deterioration of optical performance.

Thus, the baffle 400 is not a static structure but can be a smart baffle that deforms based on sensing data.

The sensing unit 100 has a self-powering function, and the driving unit 300 can control the baffle 400 based on the self-powering function.

The baffle 400 can perform optimal stray light blocking by folding or unfolding, and can be fully integrated with the existing optical mechanical structure.

This exemplary embodiment is an electroactive or photoactive variable baffle, not a conventional fixed baffle.

While a conventional baffle increases weight, the baffle 400 according to this exemplary embodiment can be made lightweight by applying an electroactive polymer.

Moreover, while a conventional baffle is always flat, the baffle 400 according to this exemplary embodiment is activated only when needed, maintaining optimal performance.

In other words, as a smart baffle, the baffle 400 according to this exemplary embodiment can operate without external power, prevent unnecessary deterioration of optical performance through perfect integration with the optical system, and allow precise control of its deformation speed for optimal stray light removal.

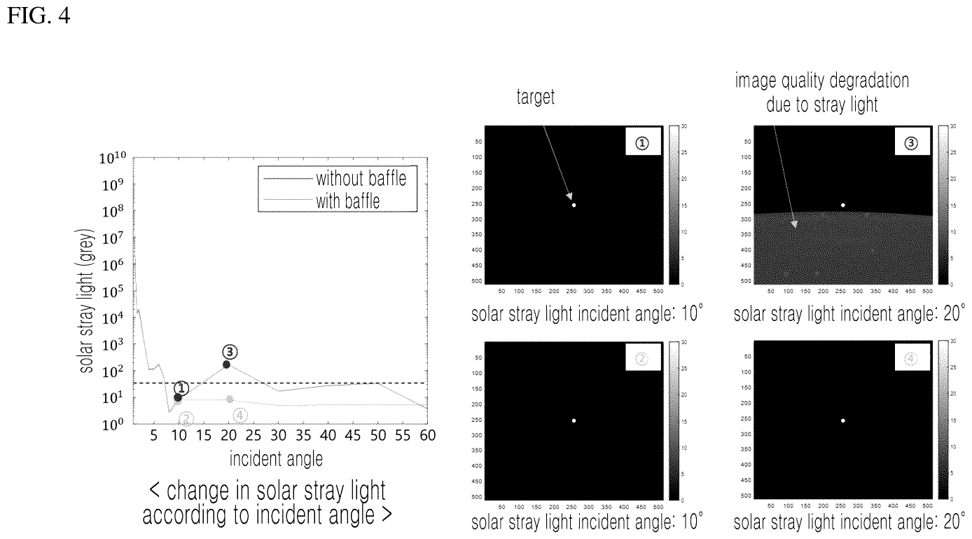

FIG. 4 is a graph illustrating a change in solar stray light depending on an incident angle.

Referring to FIG. 4, the results of analyzing the influence of an electroactive or photoactive baffle 400 on solar stray light are visually illustrated.

That is, through the graph and image analysis shown in FIG. 4, the effect of reducing stray light before and after the application of the baffle 400 can be compared.

The graph shown in FIG. 4 illustrates the change in solar stray light depending on whether the baffle 400 is applied.

The X-axis represents the angle of incidence of sunlight, with experiments conducted in the range of 5° to 60°.

The Y-axis represents the intensity of solar stray light in grey value.

A larger Y value indicates a greater influence of stray light entering the EO/IR system.

The blue curve represents the case without the baffle 400, showing that when the baffle 400 is absent, stray light increases sharply at specific incidence angles, particularly in the 10° to 20° range.

This indicates that solar stray light significantly affects the image quality of the EO/IR system.

The red curve represents the case with the baffle 400 applied, showing that overall stray light is reduced.

In particular, a large difference is observed in the 10° to 20° range where stray light increases sharply, indicating that the baffle 400 effectively blocks solar stray light.

Therefore, applying the baffle 400 can effectively mitigate the problem of stray light increasing sharply at certain incidence angles, maintain the image quality of the infrared imaging EO/IR system, and prevent false detection.

Meanwhile, the images in FIG. 4 compare the effect of removing solar stray light.

Each image shows the difference in image quality depending on the change in the incidence angle of solar stray light.

The top left of FIG. 4 shows an image with a solar stray light incidence angle of 10° without the baffle 400.

The target is clearly visible, but some stray light exists in the background, which may interfere with the EO/IR system's performance.

The bottom left of FIG. 4 shows an image with a solar stray light incidence angle of 10° with the baffle 400 applied.

With the baffle 400 applied, the stray light is removed, the background becomes darker, and the target appears more clearly.

The top right of FIG. 4 shows an image with a solar stray light incidence angle of 20° without the baffle 400.

The stray light affects the entire image of the infrared imaging EO/IR system, significantly degrading image quality.

In particular, brightness distortion occurs in the lower part of the infrared imaging EO/IR system due to stray light, which can cause the EO/IR system to fail to properly detect the target.

The bottom right of FIG. 4 shows an image with a solar stray light incidence angle of 20° with the baffle 400 applied.

After applying the baffle 400, most of the stray light is removed, the background becomes darker, and the target is clearly detected.

That is, the baffle 400 plays a role in stably maintaining image quality.

Therefore, in this exemplary embodiment, without the baffle 400, solar stray light significantly degrades image quality at specific incidence angles, while applying the baffle 400 blocks the stray light and enables more accurate target detection.

This plays an important role in improving the performance of the infrared imaging EO/IR system and preventing false detection.

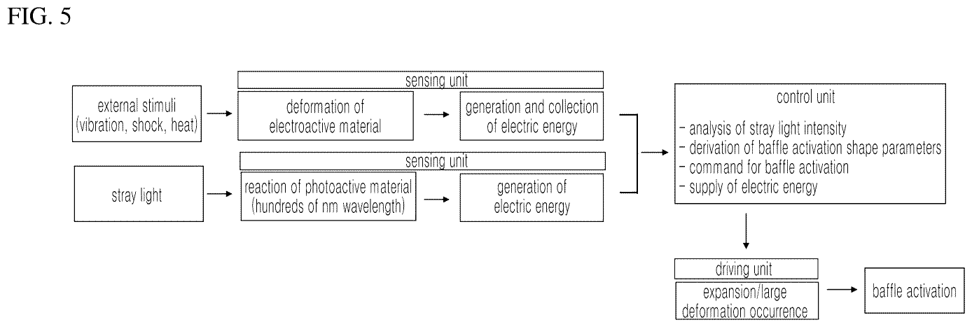

FIG. 5 is a block diagram illustrating a configuration of a stray light removal system according to an embodiment of the present disclosure.

Referring to FIG. 5, a stray light removal system according to an exemplary embodiment of the present invention includes a sensing unit 100, a control unit 200, an electrode unit, a driving unit 300, and a baffle 400.

The sensing unit 100 detects stray light or external stimuli and generates an electric signal.

The electrode unit controls the electric signal generated by the sensing unit 100 and transmits the electric signal to the control unit 200.

The sensing unit 100 may include an electroactive polymer material of a ferroelectric polymer series and a photoactive material configured to generate an electric signal according to the intensity of stray light.

In this exemplary embodiment, the sensing unit 100 may generate electric energy through the electrode unit according to deformation of the electroactive polymer material upon a change in external stimuli and collect and store the generated electric energy in real time.

The sensing unit 100 may also generate electric energy through the electrode unit according to a photoelectric reaction of the photoactive material upon a change in stray light.

The control unit 200 analyzes stray light intensity based on the electric signal transmitted by the electrode unit.

Here, the control unit 200 supplies electric energy to the driving unit 300, derives baffle activation shape parameters, and provides a baffle activation command.

The driving unit 300 operates under control of the control unit 200.

Here, the driving unit 300 may include an electroactive polymer of a dielectric elastomer series.

The baffle 400 has its length or angle adjusted by operation of the driving unit 300 to remove stray light.

Here, the baffle 400 may include an electroactive polymer (EAP: Electro Active Polymer) material and a photoactive material.

The electroactive polymer material may be one selected from the group consisting of a polymer material of a ferroelectric polymer series, a polymer material of a dielectric elastomer series, and a material in which the polymer material of a ferroelectric polymer series is mixed with the polymer material of a dielectric elastomer series.

The electroactive polymer material may also be applied in a metal-electroactive polymer hybrid form.

Meanwhile, the photoactive material may be a material of an antimony chalcohalide series.

The antimony chalcohalide series may include, for example, antimony sulfide iodide (SbSI), antimony sulfide bromide (SbSBr), and antimony selenide iodide (SbSeI).

Antimony sulfide iodide is a representative photovoltaic and ferroelectric material with high solar reactivity, suitable for optical sensors and solar cells.

Antimony sulfide bromide has properties similar to those of antimony sulfide iodide but contains bromine, resulting in different electrical characteristics, and is suitable for piezoelectric and sensor applications.

Antimony selenide iodide has a wider bandgap than antimony sulfide iodide and is suitable for solar cell and semiconductor applications.

Antimony selenide iodide has excellent infrared (IR) and solar reactivity, therefore is suitable for thermoelectric and optoelectronic applications.

Such photoactive materials generate higher electric energy according to the intensity of stray light (wavelengths in the hundreds of nm range) caused by sunlight.

Since these photoactive materials are in powder form, they may be mixed with the electroactive polymer material.

The shape of the baffle 400 can be freely cut according to the shape of the application structure and can be locally activated only in portions necessary for removing stray light generated from the sun under specific attitudes and angles of the flight vehicle.

The baffle 400 includes the sensing unit 100 and the driving unit 300, and it is appropriate that the sensing unit 100 be configured with an electroactive polymer of a ferroelectric polymer series having a fast electro-mechanical response speed and an antimony chalcohalide material for reacting to solar stray light, and that the driving unit 300 be configured with an electroactive polymer of a dielectric elastomer series having large deformation and high energy efficiency.

The sensing unit 100 can collect and store electric energy in real time through an electrode without an external power supply, by utilizing changes in electrical signals according to changes in the thickness of the electroactive polymer when the operating environment (such as heat or vibration) changes.

The collected electric energy is stored in a separate device, and the collected electric energy (W) is as shown in the following Equation 1.

$$W = \frac{1}{2} QV = \frac{1}{2} ( d \times σ \times A ) ( g \times σ \times {t}_{EAP} ) = \frac{1}{2} d \times g \times {σ}^{2} \times volume \qquad [ Equation 1 ]$$

Here, W is the collected electrical energy, Q is the charge collected through the electrode, V is the voltage, σ is the applied stress, d is the current constant, g is the voltage constant, A is the active area of the electroactive polymer, and t_{EAP} is the thickness of the EAP.

The stored electrical energy in this manner is used to activate the electroactive polymer baffle 400.

The relationship between the electrical signal generated from the electroactive polymer and the pressure (force) applied to the electroactive polymer baffle 400 is represented by the following Equation 2.

$${V}_{EAP} = - ( \frac{{t}_{EAP}}{{ϵ}_{33} A} ) {d}_{33} {F}_{c} = - \frac{q}{{C}_{EAP}} = V + {\int }_{t} \frac{{i}_{EAP}}{{C}_{EAP}} dt \\ {C}_{EAP} = {ϵ}_{33} \frac{A}{{t}_{EAP}} \qquad [ Equation 2 ]$$

Here, V_{EAP} is the voltage signal generated from the electroactive polymer, t_{EAP} is the thickness of the electroactive polymer, ε₃₃ is the mechanical stress vector, A is the active area of the EAP, d₃₃ is the piezoelectric strain coefficient, F_{c} is the contact force, C_{EAP} is the capacitance of the electroactive polymer, V is the open-circuit voltage, and i_{EAP} is the current generated from the electroactive polymer.

In the present exemplary embodiment, the baffle 400 may require an auxiliary voltage supply device, but basically operates in a manner using power harvested by self-generation.

In the driving unit 300, at the time when removal of scattered light is required, the electrical energy collected from the sensing unit 100 is supplied through the electrode unit, thereby activating the baffle.

Parameters, such as length and angle, necessary for activation of the baffle 400 for removing scattered light, may be determined by Equation 3 below.

$${P}_{EAP} = {ϵ}_{r} {ϵ}_{0} {E}^{2} = {ϵ}_{r} {{ϵ}_{0} ( \frac{{V}_{applied}}{{t}_{EAP}} )}^{2} \qquad [ Equation 3 ]$$

Here, P_{EAP} is the pressure generated in the electroactive polymer, εᵣ is the dielectric constant, co is the vacuum permittivity, E is the applied electric field, V_{applied} is the applied voltage, and t_{EAP} is the thickness of the electroactive polymer.

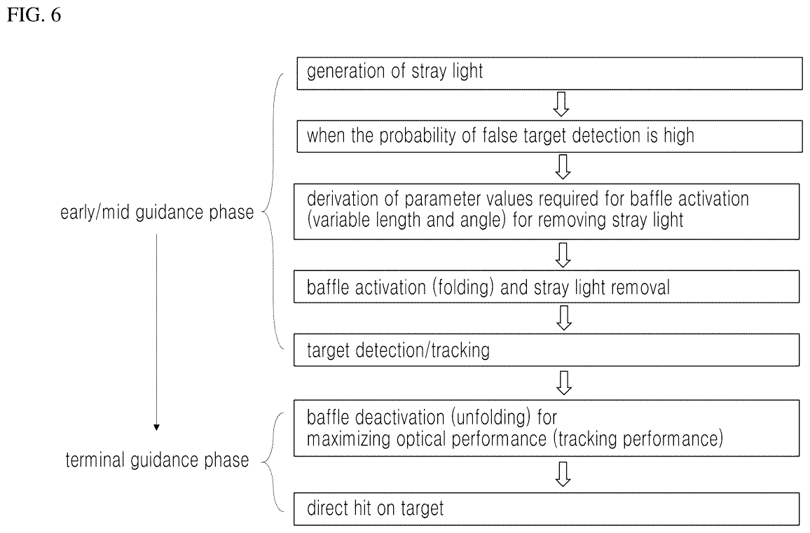

FIG. 6 is a diagram illustrating a flow in which a EO/IR system detects or tracks a target and makes a direct hit.

Referring to FIG. 6, the operational process of a stray light removal and target detection system using an electroactive or photoactive baffle 400 is illustrated.

The figure shows the entire sequence in which the electroactive or photoactive baffle 400 removes stray light, detects a target, and proceeds to a direct hit (strike).

The main process is divided into an early/mid guidance phase and a terminal guidance phase.

This demonstrates that activation and deactivation of the baffle 400 are dynamically performed. In the early/mid guidance phase, stray light removal and target detection are carried out.

In the initial stage, the EO/IR system's target detection performance may deteriorate due to the influence of solar stray light and surrounding light sources.

Therefore, the baffle 400 is activated (folding) to remove the stray light.

In generation of stray light, the EO/IR system is affected by solar light, cloud reflection, and ground reflection, which introduces scattered light into the system.

This can be a major cause of performance degradation.

When stray light increases, the EO/IR system is more likely to confuse the target with stray light, thereby increasing probability of false target detection.

This increases the probability of false detection.

To address this, the baffle 400 is activated.

In derivation of baffle activation parameters, in order to remove stray light, the length and angle of the baffle 400 must be adjusted.

Here, the sensing unit 100 measures stray light intensity and calculates the optimal baffle activation parameters.

In baffle activation (folding) and stray light removal, the driving unit 300, in response to the sensing unit 100's signal, activates the baffle.

As the baffle 400 deploys, stray light is blocked, enhancing the EO/IR system's image quality.

This results in improved target detection/tracking performance, reduced false detection probability, and enhanced image quality.

In the terminal guidance phase, target detection and direct strike are performed.

The EO/IR system's goal is to detect and strike the target under optimal conditions.

Therefore, after stray light is removed, the baffle 400 may be deactivated (unfolding) to maximize optical performance.

In target detection and tracking, with the baffle activated, the EO/IR system detects and tracks the target in real time.

Thanks to stray light removal, the target's position can be identified more accurately.

In baffle deactivation, once the target is firmly detected, the baffle is retracted to maximize optical performance.

This further improves tracking capability and maximizes the EO/IR system's field of view.

When the baffle 400 is deactivated, the optical system can continue precision tracking until the final moment.

In target impact, ultimately, the EO/IR system strikes the target based on accurate data.

The baffle 400 may help prevent false detections and ensures the EO/IR system reaches the target precisely.

This maximizes optical (tracking) performance and enables a precision strike.

In summary, the electroactive or photoactive baffle 400 operates in real time to maintain image quality and enhance target detection performance.

In the early/mid guidance phase, the baffle 400 is activated to block stray light and reduce the EO/IR system's false detection rate.

In the terminal guidance phase, the baffle 400 is deactivated to maintain optimal optical performance and enable precise target engagement.

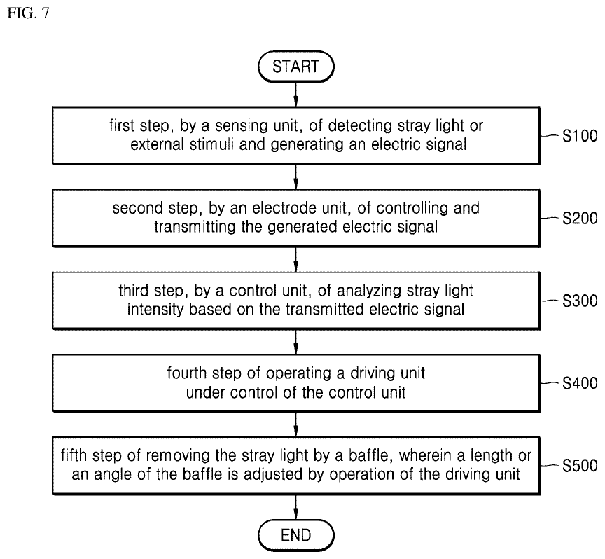

FIG. 7 is a flowchart illustrating an overall flow of a stray light removal method according to another embodiment of the present disclosure.

The stray light removal system according to the present disclosure described above operates by the method for removing stray light.

Referring to FIG. 7, the stray light removal method according to another exemplary embodiment of the present disclosure comprises five steps.

In the first step (S100), stray light or an external stimulus is detected by the sensing unit 100 to generate an electrical signal.

The sensing unit 100 may include an electroactive polymer material of a ferroelectric polymer series and a photoactive material that generates an electrical signal according to the intensity of stray light.

The sensing unit 100 may generate electrical energy through the electrode unit according to deformation of the electroactive polymer material when an external stimulus changes, and may collect and store the generated electrical energy in real time.

In addition, the sensing unit 100 may generate electrical energy through the electrode unit according to a photovoltaic reaction of the photoactive material when stray light changes.

In the second step (S200), the electrical signal generated by the sensing unit 100 is controlled by the electrode unit and delivered to the electrode unit.

In the third step (S300), the intensity of stray light is analyzed by the control unit 200 based on the electrical signal delivered to the electrode unit.

The control unit 200 supplies electrical energy to the driving unit 300, derives baffle activation shape parameters, and provides a baffle activation command.

In the fourth step (S400), the driving unit 300 operates under the control of the control unit 200.

In the fifth step (S500), the baffle 400, of which length or angle is adjusted by the operation of the driving unit 300, removes stray light.

The driving unit 300 may include an electroactive polymer of a dielectric elastomer series.

In the stray light removal method according to the present disclosure, the baffle is characterized by comprising an electroactive polymer (EAP) material and a photoactive material.

The electroactive polymer material may be one selected from the group consisting of a ferroelectric polymer series material, a dielectric elastomer series material, and a material in which the ferroelectric polymer series material and the dielectric elastomer series material are mixed.

The photoactive material may be a material of an antimony chalcohalide series.

As described above, according to the present disclosure, it is possible to effectively remove stray light generated by direct sunlight, clouds, ground-reflected light, and the like, thereby obtaining high-quality infrared images, improving detection and tracking performance of a EO/IR system by removing the stray light, and minimizing the possibility of false detection.

Furthermore, according to the present disclosure, it is possible to solve the problem in which a conventional metal baffle partially blocks infrared energy and deteriorates optical performance, to maintain or improve the quality of an infrared signal while removing stray light, and to provide stable and clear infrared images by eliminating vignetting phenomena and distortions caused by bright spots.

Furthermore, according to the present disclosure, by using an Electroactive Polymer (EAP) and a photoactive material instead of a conventional metal baffle, it is possible to significantly reduce the weight of the baffle, improve mechanical performance, flight speed, and flight range of a flight vehicle, and maximize flight vehicle performance through system weight reduction.

Furthermore, according to the present disclosure, by harvesting electric energy through self-generation using external stimuli (vibration, heat, shock, etc.), storing the electric energy, and using it for baffle activation, it is possible to achieve efficient energy use without a separate power supply device and to solve energy supply problems.

Furthermore, according to the present disclosure, a system composed of a sensing unit and a driving unit detects changes in an external environment in real time, activates the baffle only when necessary, and locally operates the baffle, thereby reducing unnecessary energy consumption and preventing deterioration of optical performance.

Furthermore, according to the present disclosure, since the system can actively respond to various external stimuli such as vibration, heat, and shock generated during flight, and can perform self-generation and baffle activation, stable operation is possible under various environmental conditions.

Furthermore, according to the present disclosure, bright spots in infrared images caused by stray light can be effectively removed, enabling accurate detection and tracking of a target, minimizing detection errors, reducing the possibility of mission failure, and improving system reliability.

Furthermore, according to the present disclosure, the shape and activation area of the baffle can be flexibly designed to match the posture and angle conditions of a specific flight vehicle, and various types of photoactive materials or hybrid structures of metal and electroactive polymers can be applied as needed, thereby providing high versatility.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: sensing unit
200: control unit
300: driving unit
400: baffle

What is claimed is:

1. A stray light removal system, comprising:
a sensing unit configured to detect stray light or external stimuli and generate an electric signal;
an electrode unit configured to control and transmit the generated electric signal;
a control unit configured to analyze stray light intensity based on the transmitted electric signal;
a driving unit configured to operate under control of the control unit; and
a baffle, wherein a length or an angle of the baffle is adjusted by operation of the driving unit to remove the stray light.

2. The stray light removal system of claim 1,
wherein the control unit is configured to supply electric energy to the driving unit, to derive baffle activation shape parameters, and to provide a baffle activation command.

3. The stray light removal system of claim 1,
wherein the baffle includes an electroactive polymer (EAP: Electro Active Polymer) material and a photoactive material.

4. The stray light removal system of claim 3,
wherein the electroactive polymer material is one selected from the group consisting of a polymer material of a ferroelectric polymer series, a polymer material of a dielectric elastomer series, and a material in which the polymer material of a ferroelectric polymer series is mixed with the polymer material of a dielectric elastomer series.

5. The stray light removal system of claim 3,
wherein the photoactive material is a material of an antimony chalcohalide series.

6. The stray light removal system of claim 1,
wherein the driving unit includes an electroactive polymer of a dielectric elastomer series.

7. The stray light removal system of claim 1,
wherein the sensing unit includes an electroactive polymer material of a ferroelectric polymer series and a photoactive material configured to generate the electric signal depending on an intensity of the stray light.

8. The stray light removal system of claim 7,
wherein the sensing unit generates electric energy according to deformation of the electroactive polymer material upon a change in the external stimuli, and collects and stores the generated electric energy in real time through the electrode unit.

9. The stray light removal system of claim 7,
wherein the sensing unit generates electric energy through the electrode unit according to a photoelectric reaction of the photoactive material upon a change in the stray light.

10. A method for removing stray light, comprising:
a first step, by a sensing unit, of detecting stray light or external stimuli and generating an electric signal;
a second step, by an electrode unit, of controlling and transmitting the generated electric signal;
a third step, by a control unit, of analyzing stray light intensity based on the transmitted electric signal;
a fourth step of operating a driving unit under control of the control unit; and
a fifth step of removing the stray light by a baffle, wherein a length or an angle of the baffle is adjusted by operation of the driving unit.

11. The method of claim 10,
wherein the control unit is configured to supply electric energy to the driving unit, to derive baffle activation shape parameters, and to provide a baffle activation command.

12. The method of claim 10,
wherein the baffle includes an electroactive polymer (EAP: Electro Active Polymer) material and a photoactive material.

13. The method of claim 12,
wherein the electroactive polymer material is one selected from the group consisting of a polymer material of a ferroelectric polymer series, a polymer material of a dielectric elastomer series, and a material in which the polymer material of a ferroelectric polymer series is mixed with the polymer material of a dielectric elastomer series.

14. The method of claim 12,
wherein the photoactive material is a material of an antimony chalcohalide series.

15. The method of claim 10,
wherein the driving unit includes an electroactive polymer of a dielectric elastomer series.

16. The method of claim 10,
wherein the sensing unit includes an electroactive polymer material of a ferroelectric polymer series and a photoactive material configured to generate the electric signal depending on an intensity of the stray light.

17. The method of claim 16,
wherein the sensing unit generates electric energy according to deformation of the electroactive polymer material upon a change in the external stimuli, and collects and stores the generated electric energy in real time through the electrode unit.

18. The method of claim 16,
wherein the sensing unit generates electric energy through the electrode unit according to a photoelectric reaction of the photoactive material upon a change in the stray light.

19. A stray light removal system operated by the method according to claim 10.
